(19) United States
(12) Patent Application Publication
(10) Pub. No.: US 2025/0217127 A1
(43) Pub. Date: Jul. 3, 2025

(54) USING CROSS-COMPILATION TO DETERMINE TRANSLATION ACCURACY OF ARTIFICIAL INTELLIGENCE GENERATED CODE

(71) Applicant: INTERNATIONAL BUSINESS MACHINES CORPORATION, ARMONK, NY (US)

(72) Inventors: ANDREW C. M. HICKS, HIGHLAND, NY (US); MICHAEL GAGLIARDI, SOMERSET, MA (US); RYAN LO, POUGHKEEPSIE, NY (US); DESMOND FITZPATRICK, OSSINING, NY (US)

(21) Appl. No.: 18/398,682

(22) Filed: Dec. 28, 2023

(51) Int. Cl. G06F 8/51; G06F 8/77

(52) U.S. Cl. CPC G06F 8/51; G06F 8/77

(57) ABSTRACT

Using cross-compilation to determine translation accuracy of artificial intelligence generated code includes receiving a first code portion of a first programming language, converting the first code portion to a second code portion of a second programming language by a generative artificial intelligence model, and converting the second code portion to a third code portion of the first programming language by the generative artificial intelligence model. A translation accuracy score of the converting of the first code portion to the second code portion is calculated.

### BACKGROUND

The present disclosure relates to methods, apparatus, and products for using cross-compilation to determine translation accuracy of artificial intelligence generated code. Migrating the functionality of legacy source code to a more modern programming language can increase the maintainability and readability of the source code as well as improve system performance. However, such a migration is an arduous task that can include writing, testing, validating, and debugging massive amounts of code. If the modernized source code is deployed with errors into a complex software system, expected operations may fail to complete, exhaustive retry logic may hog resources, transactions can begin to fail, and entire components of the stack may fail, leading to a potential outage. This can be disastrous, especially in core production systems.

### SUMMARY

According to embodiments of the present disclosure, various methods, apparatus and products for using cross-compilation to determine translation accuracy of artificial intelligence generated code are described herein. In some aspects, a method for using cross-compilation to determine translation accuracy of artificial intelligence generated code includes receiving a first code portion of a first programming language; converting the first code portion to a second code portion of a second programming language by a generative artificial intelligence model; converting the second code portion to a third code portion of the first programming language by the generative artificial intelligence model; and calculating a translation accuracy score of the converting of the first code portion to the second code portion.

In an embodiment, the method further includes calculating a first complexity score for the first code portion; calculating a second complexity score for the third code portion; and calculating the translation accuracy score of the converting of the first code portion to the second code portion based on a comparison of the first complexity score and the second complexity score.

In an embodiment, calculating the first complexity score for the first code portion further comprises calculating the first complexity score for the first code portion based on one or more complexity metrics. In an embodiment, calculating the second complexity score for the third code portion further comprises calculating the second complexity score for the third code portion based on the one or more complexity metrics. In an embodiment, the one or more complexity metrics include one or more of a cyclomatic complexity metric, a Halstead metric, a live variable metric, a knot count metric, an ultrametric topology metric, and an abstract syntax tree metric.

In an embodiment, calculating the first complexity score for the first code portion further comprises calculating the first complexity score for the first code portion based on a combination of a plurality of the one or more complexity metrics. In an embodiment, calculating the first complexity score for the first code portion further comprises calculating the first complexity score for the first code portion based on a weighted combination of a plurality of the one or more complexity metrics.

An embodiment further includes updating the generative artificial intelligence model based on the translation accuracy score. In an embodiment, calculating the translation accuracy score of the converting of the first code portion to the second code portion based on the comparison of the first complexity score and the second complexity score further includes: calculating a difference between the first complexity score and the second complexity score; and calculating the translation accuracy score based on the difference between the first complexity score and the second complexity score.

An embodiment further includes indicating that the translation accuracy score is outside of an acceptable tolerance. In an embodiment, the generative artificial intelligence model comprises a large language model. An embodiment further includes determining that the first code portion and the second code portion have a same functionality.

In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a block diagram of an example computing environment for using cross-compilation to determine translation accuracy of artificial intelligence generated code in accordance with some embodiments of the present disclosure.

FIG. 2 sets forth a flowchart of an example method for using cross-compilation to determine translation accuracy of artificial intelligence generated code in accordance with some embodiments of the present disclosure.

FIG. 3 sets forth a flowchart of another example method for using cross-compilation to determine translation accuracy of artificial intelligence generated code in accordance with some embodiments of the present disclosure.

FIG. 4 sets forth a flowchart of another example method for using cross-compilation to determine translation accuracy of artificial intelligence generated code in accordance with some embodiments of the present disclosure.

FIG. 5 sets forth a flowchart of another example method for using cross-compilation to determine translation accuracy of artificial intelligence generated code in accordance with some embodiments of the present disclosure.

FIG. 6 sets forth a flowchart of another example method for using cross-compilation to determine translation accuracy of artificial intelligence generated code in accordance with some embodiments of the present disclosure.

FIG. 7 sets forth a flowchart of another example method for using cross-compilation to determine translation accuracy of artificial intelligence generated code in accordance with some embodiments of the present disclosure.

### DETAILED DESCRIPTION

The advent of large language models and other improvements to artificial intelligence (AI) technology have enabled AI to generate source code. Large language models (LLMs), for example, are trained on massive datasets of source code to provide generative AI that outputs source code based on some input or prompt. As will discussed in further detail below, the migration of an application from its original source code to new source code can be assisted by such AI. That is, the AI can be used to generate new source code based on an input of original source code. For example, an LLM may be given a prompt such as “Generate Java code that achieves the same objectives as the following COBOL code,” where the legacy COBOL source code is provided as an input. In response, the LLM may output, at least ideally, AI-generated Java source code that performs the same functions and produces the same output as the legacy. Of course, any new source code, whether human or AI generated, is susceptible to the introduction of bugs, execution errors, or other faults.

Embodiments in accordance with the present disclosure advantageously utilize cross-compilation to determine translation accuracy of artificial intelligence generated code when translating from original source code in a first programming language (e.g., COBOL) into converted source code in a second programming language (e.g., Java). LLMs have significantly advanced the process of translating code from one programming language to another. However, challenges arise when the translated output code deviates from an acceptable standard. An accurately built LLM used to translate code from a first programing language to a second programming language should be able to produce consistent translations in both translation directions when using cross-compilation. That is, the same LLM should be able to translate the newly generated code in the second programming language back to code in the first programming language to produce functionally identical code to the original code in the first programming language. Various embodiments recognize that back-and-forth translation (e.g., cross-compilation) of code and then subsequent analysis of loss in translation can be used to quantify whether the translated code fails within an acceptable accuracy bound or tolerance. As a result, various embodiments allow deriving whether the translation process is deemed accurate within the acceptable tolerance.

In an embodiment, a first code portion of a first programming language (e.g., COBOL) is received and converted into a second code portion of a second programming language (e.g., Java) using a generative artificial intelligence (AI) model. The second code portion of the second programming language is converted back to a third code portion of the first programming language (e.g., cross-compiled) using the generative AI model. In a particular embodiment, the generative AI model is an LLM. A first complexity score is calculated for the first code portion, and a second complexity score is calculated for the third code portion. In particular embodiments, the respective complexity scores are calculated using one or more complexity metrics as further described herein. A translation accuracy score of the converting of the first code portion to the second code portion is calculated based on a comparison of the first complexity score and the second complexity score. The translation accuracy score is indicative of the accuracy of the generative AI in translating of the first code portion to the second code portion. In a particular embodiment, the translation accuracy score is expressed as a percentage such as 90% accuracy.

In one or more embodiments, the generative AI model is updated based on the translation accuracy score. For example, if the translation accuracy score meets an acceptable accuracy tolerance value, the generative AI model is updated based on the results of the translation. Conversely, if the translation accuracy score does not meet the acceptable tolerance value, the results of the translations may be disregarded or deprecated when updating or further training the generative AI model. In particular embodiments, subsections of code that fail to map correctly are identified during the back-and-forth translation and supplied to the generative AI model for training, correction, or validation.

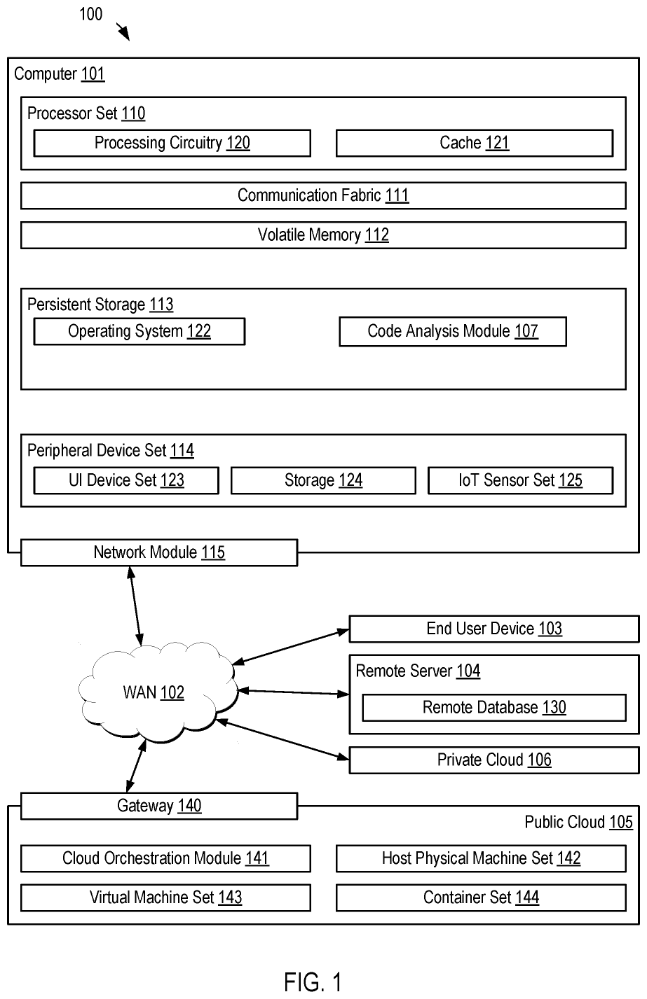

With reference now to FIG. 1, shown is an example computing environment according to aspects of the present disclosure. Computing environment 100 contains an example of an environment for the execution of at least some of the computer code involved in performing the various methods described herein, such as the code analysis module 107. In addition to the code analysis module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code analysis module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in code analysis module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in code analysis module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

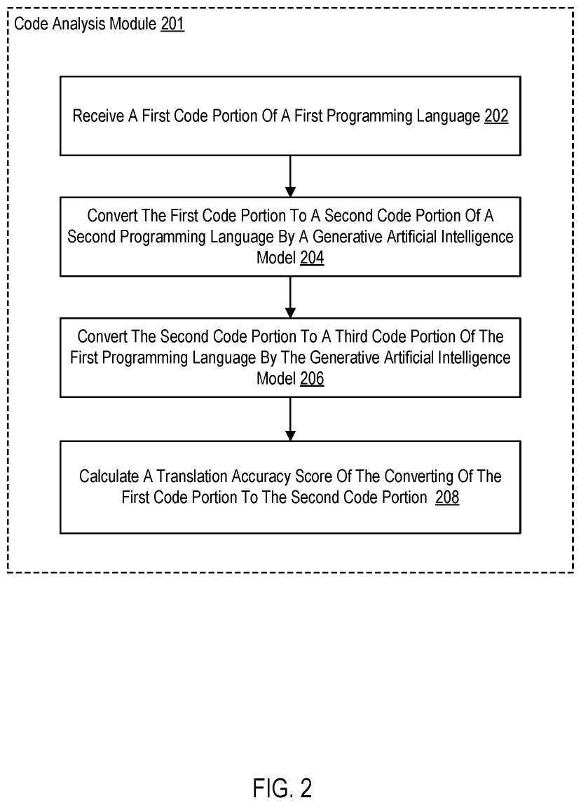

For further explanation, FIG. 2 sets forth a flowchart of an example method for using cross-compilation to determine translation accuracy of artificial intelligence generated code in accordance with some embodiments of the present disclosure. The method of FIG. 2 may be performed, for example, by a code analysis module 201 such as the code analysis module 107 of FIG. 1. In some embodiments, the code analysis module 201 may be implemented as a process or service separate from an application or software implementing code analysis. For example, the code analysis module 201 may be implemented by an operating system or other software that monitors the behavior and execution of an application implementing code analysis. As another example, in some embodiments, the code analysis module 201 may be implemented as a process or service that applies modifications to applications implementing code analysis.

The method of FIG. 2 includes receiving 202 a first code portion of a first programming language, and converting 204 the first code portion to a second code portion of a second programming language by a generative artificial intelligence (AI) model. In an embodiment, the generative AI model is an LLM. Although FIG. 2 describes execution of an application, it is understood that the approaches set forth herein may be applied to any software or module capable of implementing code analysis, including applications, operating systems, libraries, and the like. In an example, the first code portion may include legacy source code written in an older programming language (e.g., COBOL) and the second code portion may include code written in a modern programming language (e.g., Java). In a particular example, both the first code portion and the second code portion are intended to achieve the same objectives, provide the same interfaces, and produce the same output. In particular examples, the first code portion may include an application, a subroutine, a function, or driver. In some examples, some or all of the converted code is generated utilizing an AI language model. For example, some or all of the original source code can be provided as an input to the AI language model with a request (e.g., a prompt) to generate source code in a different programming language that achieves the same objectives as the original source code.

The method of FIG. 2 further includes converting 206 the second code portion to a third code portion of the first programming language by the generative AI model. That is the second code portion is translated back to the first programming language of the original code to produce the third code portion. The method of FIG. 2 further includes calculating 208 a translation accuracy score of the converting of the first code portion to the second code portion. In particular embodiment, the translation accuracy score is based on a greater degree of similarity between the first code portion and the second code portion, and thus indicative of a degree of similarity between the first code and the second code. A greater degree of similarity produces a higher translation accuracy score and is indicative of a greater degree of accuracy in the translation of the first code portion to the second code portion. Accordingly, the translation accuracy score is indicative of an accuracy of the translation from the first code portion of the first programming language to the second code portion of the second programming language by the generative AI model. In an embodiment, the code analysis module 201 further determines whether the first code portion and the second code portion have the same functionality, for example, if the first code portion and the second code portion performs the same functions and/or provide the same output for a particular input. If the first code portion and the second code portion are determined not to have the same functionality despite having an acceptable translation accuracy score, the code analysis module 201 provides an indication that the translated code is not accurate despite having an acceptable translation accuracy score.

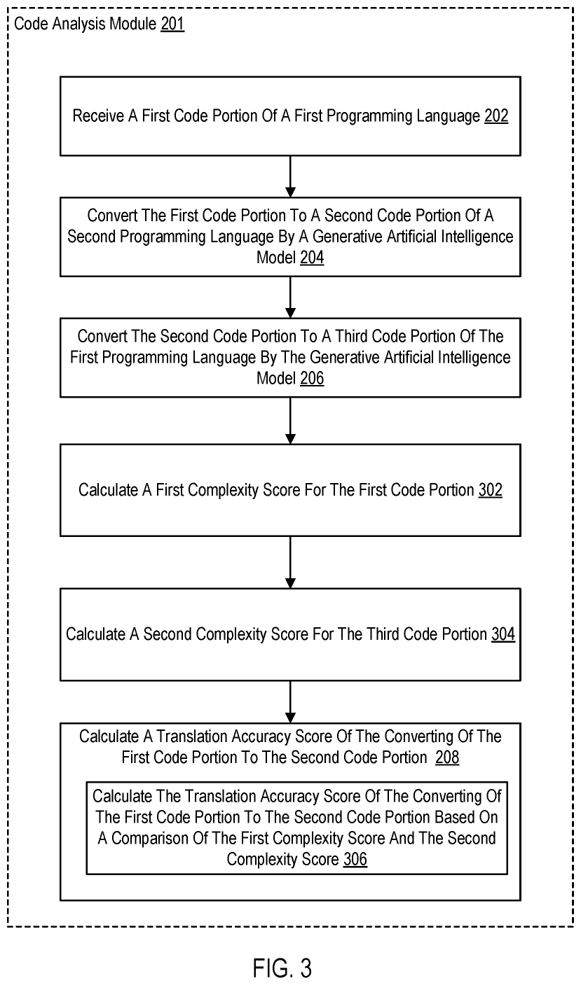

For further explanation, FIG. 3 sets forth a flowchart of an example method for using cross-compilation to determine translation accuracy of artificial intelligence generated code in accordance with some embodiments of the present disclosure. The method of FIG. 3 extends the method of FIG. 2 and further includes calculating 302 a first complexity score for the first code portion, and calculating 304 a second complexity score for the third code portion. The first and second complexity scores are representative of a respective complexity of code structure of the first code portion and the third code portion, respectively.

In one or more embodiments, calculating the first complexity score and the second complexity score is based on one or more complexity metrics. In a particular embodiment, an abstract syntax tree (AST) is used to calculate the complexity of each of the first code portion and the second code portion. An AST is a data structure used to represent the structure of the code portion in a tree representation of the abstract syntactic structure of text of the programming language. Each node of the tree denotes a construct occurring in the text. The syntax is “abstract” in the sense that it does not represent every detail appearing in the real syntax, but rather just the structural or content-related details. Compared to the source code, the AST does not typically include inessential punctuation and delimiters. By comparing ASTs of the original code portion and the converted code portion, a measure of the complexity of each of the first code portion and the third code portion is calculated. Correctly translated source code is expected to exhibit a similar degree of complexity as the original source code. In one or more embodiments, comparing the code complexities of the original source code portion to the cross-compiled code portion is an indicator of accurate translation of the code from the first programming language to the second programming language.

In another example, a cyclomatic complexity metric is used to calculate the complexity of the first code portion and the third code portion. The cyclomatic complexity metric represents the number of linearly independent paths through the source code. A path is linearly independent if there is a subset of one or more paths in which the symmetric difference of their edge sets is empty. For example, if the source code contains no control flow statements, the complexity is 1 since there is only a single path through the code. If the source code includes a single conditional statement, there are two paths through the code indicating a complexity of 2.

In another example, a Halstead complexity metric is used to calculate the complexity of the first code portion and the third code portion. The Halstead complexity metric is computed statistically without program execution and takes into account factors such as the number of distinct operators, the number of distinct operands, the total number of operators, and the total number of operands. In another example, a Maintainability Index metric is used to calculate the complexity of the original code portion and the converted code portion. The Maintainability Index metric is calculated to represent the relative ease of maintaining the code portion and is calculated based on the number of statements in the code, the cyclomatic complexity, and the Halstead volume (computed as a function of the code length, number of distinct operators, and number of distinct operands).

In other examples, one or more of a live variable metric, a knot count metric, or an ultrametric topology metric may be used as complexity metrics to calculate the respective complexity scores of the first code portion and the third code portion. A live variable metric calculates the variables that are live at each point in execution of a program. A greater number of live variables may indicate a greater complexity. A knot count metric measures the number of control transfers within a program with a greater number of control transfers implying a greater complexity.

In another embodiment, calculating the first complexity score and the second complexity score is based on a combination of the one or more software metrics. In another particular embodiment, calculating the first complexity score and the second complexity score is based on a weighted combination of a plurality of the one or more complexity metrics. For example, one or more of the complexity metrics may be weighted differently than other complexity metrics in calculating the respective complexity score.

The method of FIG. 3 further includes that calculating 208 a translation accuracy score of the converting of the first code portion to the second code portion includes calculating 306 the translation accuracy score of the converting of the first code portion to the second code portion based on a comparison of the first complexity score and the second complexity score. A greater degree of similarity between the first complexity score and the second complexity score is indicative of the degree of similarity of complexity between the first code portion and the second code portion, and thus indicative of a degree of similarity between the first code and the second code. A greater degree of similarity produces a higher translation accuracy score and is indicative of a greater degree of accuracy in the translation of the first code portion to the second code portion. Accordingly, the translation accuracy score is indicative of an accuracy of the translation from the first code portion of the first programming language to the second code portion of the second programming language by the generative AI model.

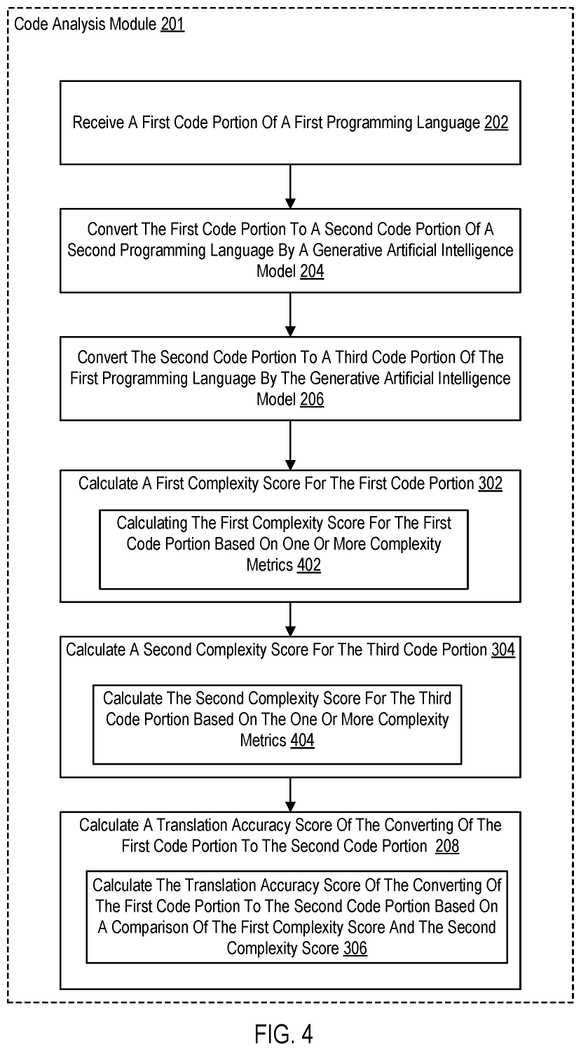

For further explanation, FIG. 4 sets forth a flowchart of another example method for using cross-compilation to determine translation accuracy of artificial intelligence generated code in accordance with some embodiments of the present disclosure. The method of FIG. 4 extends the method of FIG. 3 in that calculating 302 the first complexity score for the first code portion further includes calculating 402 the first complexity score for the first code portion based on one or more complexity metrics. In particular embodiments, the one or more complexity metrics include one or more of a cyclomatic complexity metric, a Halstead metric, a live variable metric, a knot count metric, an ultrametric topology metric, and an abstract syntax tree metric. In another embodiment, calculating 402 the first complexity score for the first code portion further includes calculating the first complexity score for the first code portion based on a combination of a plurality of the one or more complexity metrics. In still another embodiment, calculating 402 the first complexity score for the first code portion further includes calculating the first complexity score for the first code portion based on a weighted combination of a plurality of the one or more complexity metrics.

The method of FIG. 4 further extends the method of FIG. 3 in that calculating 304 the second complexity score for the third code portion further comprises calculating 404 the second complexity score for the third code portion based on the one or more complexity metrics. In a particular embodiment, the second complexity score is calculated using the same complexity metrics used for calculating the first complexity score.

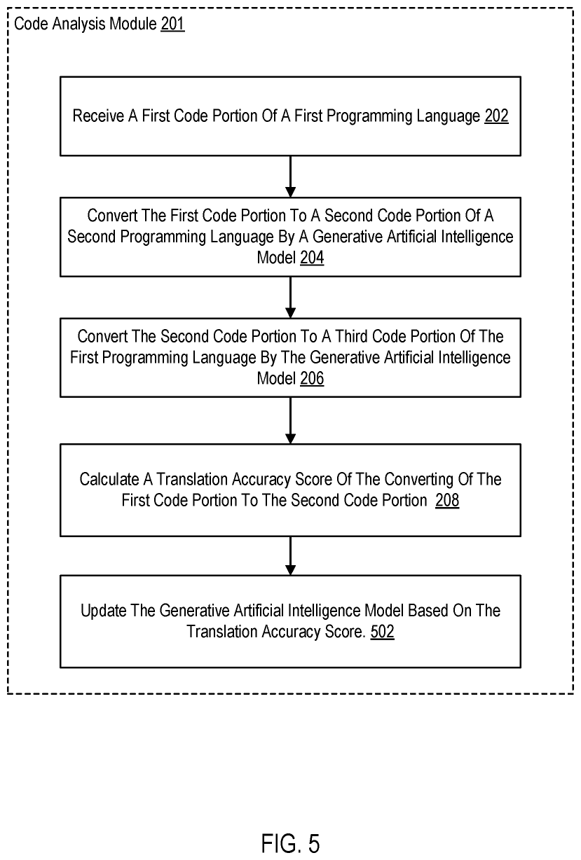

For further explanation, FIG. 5 sets forth a flowchart of another example method for using cross-compilation to determine translation accuracy of artificial intelligence generated code in accordance with some embodiments of the present disclosure. The method of FIG. 5 extends the method of FIG. 2 by further including updating 502 the generative artificial intelligence model based on the translation accuracy score. For example, if the translation accuracy score meets an acceptable accuracy tolerance value, the generative AI model is updated based on the results of the translation. Conversely, if the translation accuracy score does not meet the acceptable tolerance value, the results of the translations may be disregarded or deprecated when updating or further training the generative AI model.

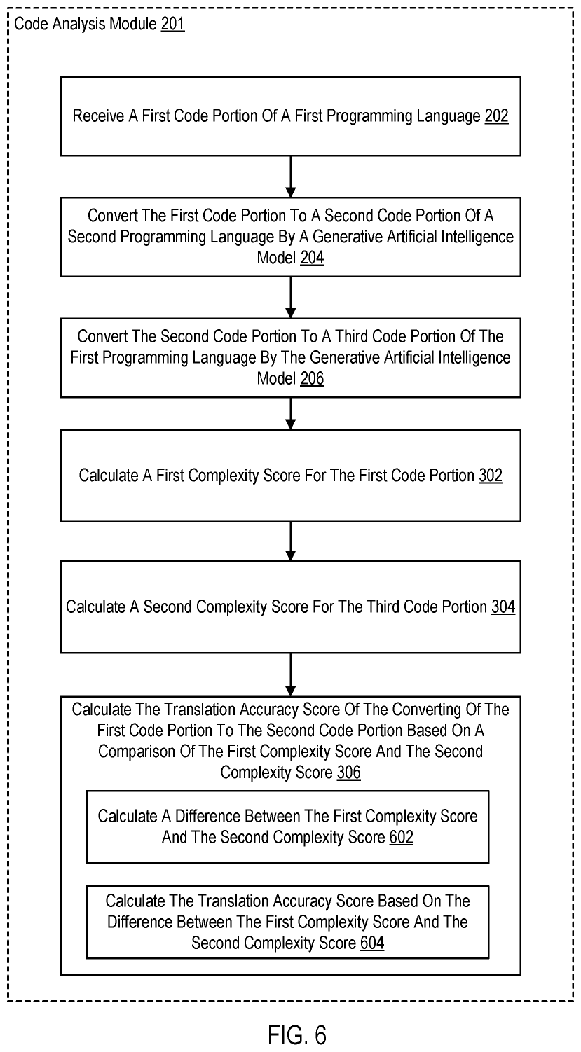

For further explanation, FIG. 6 sets forth a flowchart of another example method for using cross-compilation to determine translation accuracy of artificial intelligence generated code in accordance with some embodiments of the present disclosure. The method of FIG. 6 extends the method of FIG. 3 in that calculating 306 the translation accuracy score of the converting of the first code portion to the second code portion based on the comparison of the first complexity score and the second complexity score further includes calculating 602 a difference between the first complexity score and the second complexity score, and calculating 604 the translation accuracy score based on the difference between the first complexity score and the second complexity score. If the difference between the first complexity score and the second complexity score is relatively small, the relative complexities of the first code portion and the second code portion are substantially the same. As a result, a greater translation accuracy score is calculated. If the translation accuracy score meets an acceptable tolerance score, it is inferred that the translation of the first code portion of the first programming language to the second code portion of the second programming language is accurate to an acceptable level.

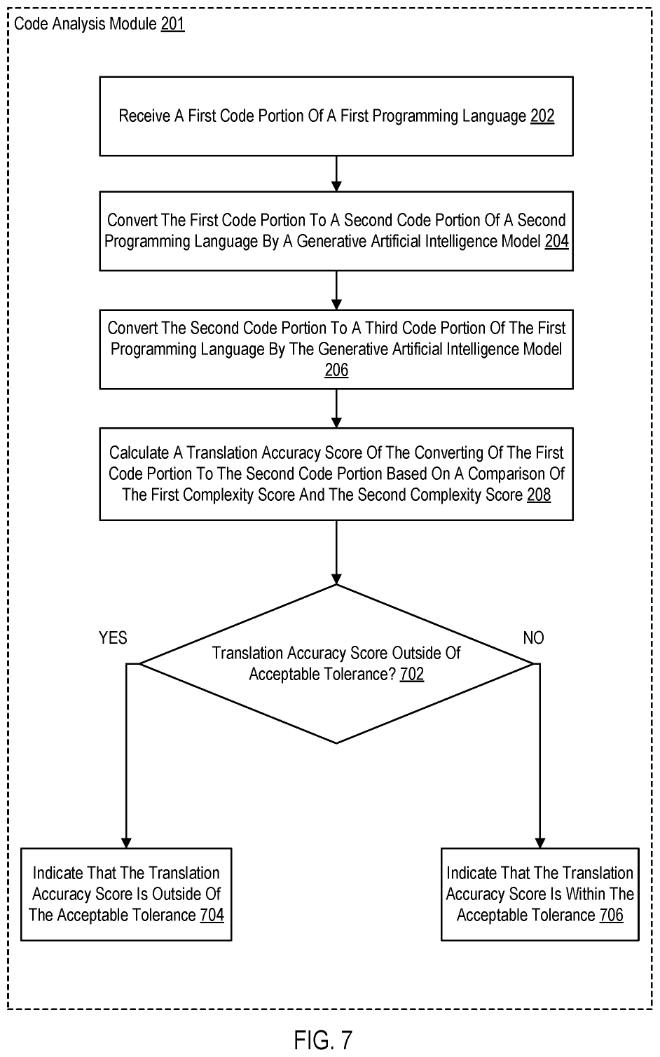

For further explanation, FIG. 7 sets forth a flowchart of another example method for using cross-compilation to determine translation accuracy of artificial intelligence generated code in accordance with some embodiments of the present disclosure. The method of FIG. 7 extends the method of FIG. 2 in that the method further includes determining 702 if the translation accuracy score is outside of an acceptable tolerance. If the translation accuracy score is outside of the acceptable tolerance, the method of FIG. 7 further includes indicating 704 that the translation accuracy score is outside of the acceptable tolerance. If the translation accuracy score is not outside of the acceptable tolerance, the method of FIG. 7 further includes indicating 706 that the translation accuracy score is within the acceptable tolerance. For example, an acceptable tolerance of 90% may be defined such that a code portion having a translation accuracy score of at least 90% is indicated as being within the acceptable tolerance. In another example, if the translation accuracy score is less than 90%, the code portion is indicated as having a translation accuracy score outside of the acceptable tolerance. In particular embodiments, further actions may be taken to improve the accuracy of translation such as iteratively retranslating the first code portion until an acceptable translation accuracy score is obtained or the translation accuracy score remains substantially unchanged between iterations.

The above-described examples are provided in the context of determining translation accuracy when migrating an application from original source code to new source code. It will be appreciated that the term ‘original source code’ as used herein refers to the instance of the application against which the new source code is being validated for accuracy, and should not be construed as limiting the term to mean the earliest implementation of that application. While embodiments are useful in migrating or porting an application from one programming language to a different programming language, and from legacy code to a more modernized programming language, it will be further appreciated that in some examples the original source code and the new source code may be written in the same programming language.

In view of the foregoing, using cross-compilation to determine translation accuracy of artificial intelligence generated code provides a number of advantages. For example, determining a translation accuracy of converting original source code is a first programming language to converted source code in a different programming language provides determining whether the converted source code has an acceptable level of accuracy or whether other measures should be taken to increase the translation accuracy.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a first code portion of a first programming language;
converting the first code portion to a second code portion of a second programming language by a generative artificial intelligence model;
converting the second code portion to a third code portion of the first programming language by the generative artificial intelligence model; and
calculating a translation accuracy score of the converting of the first code portion to the second code portion.

2. The method of claim 1, further comprising:
calculating a first complexity score for the first code portion;
calculating a second complexity score for the third code portion; and
calculating the translation accuracy score of the converting of the first code portion to the second code portion based on a comparison of the first complexity score and the second complexity score.

3. The method of claim 2, wherein calculating the first complexity score for the first code portion further comprises calculating the first complexity score for the first code portion based on one or more complexity metrics.

4. The method of claim 3, wherein calculating the second complexity score for the third code portion further comprises calculating the second complexity score for the third code portion based on the one or more complexity metrics.

5. The method of claim 3, wherein the one or more complexity metrics include one or more of a cyclomatic complexity metric, a Halstead metric, a live variable metric, a knot count metric, an ultrametric topology metric, and an abstract syntax tree metric.

6. The method of claim 3, wherein calculating the first complexity score for the first code portion further comprises calculating the first complexity score for the first code portion based on a combination of a plurality of the one or more complexity metrics.

7. The method of claim 3, wherein calculating the first complexity score for the first code portion further comprises calculating the first complexity score for the first code portion based on a weighted combination of a plurality of the one or more complexity metrics.

8. The method of claim 1, further comprising updating the generative artificial intelligence model based on the translation accuracy score.

9. The method of claim 2, wherein calculating the translation accuracy score of the converting of the first code portion to the second code portion based on the comparison of the first complexity score and the second complexity score further comprises:
calculating a difference between the first complexity score and the second complexity score; and
calculating the translation accuracy score based on the difference between the first complexity score and the second complexity score.

10. The method of claim 1, further comprising indicating that the translation accuracy score is outside of an acceptable tolerance.

11. The method of claim 1, wherein the generative artificial intelligence model comprises a large language model.

12. The method of claim 1, further comprising determining that the first code portion and the second code portion have a same functionality.

13. An apparatus comprising:
a processing device; and
memory operatively coupled to the processing device, wherein the memory stores computer program instructions that, when executed, cause the processing device to:
receive a first code portion of a first programming language;
convert the first code portion to a second code portion of a second programming language by a generative artificial intelligence model;
convert the second code portion to a third code portion of the first programming language by the generative artificial intelligence model; and
calculate a translation accuracy score of the converting of the first code portion to the second code portion.

14. The apparatus of claim 13, wherein the memory stores computer program instructions that, when executed, cause the processing device to:
calculate a first complexity score for the first code portion;
calculate a second complexity score for the third code portion; and
calculate the translation accuracy score of the converting of the first code portion to the second code portion based on a comparison of the first complexity score and the second complexity score.

15. The apparatus of claim 14, wherein calculating the first complexity score for the first code portion further comprises calculating the first complexity score for the first code portion based on one or more complexity metrics.

16. The apparatus of claim 15, wherein calculating the second complexity score for the third code portion further comprises calculating the second complexity score for the third code portion based on the one or more complexity metrics.

17. The apparatus of claim 15, wherein calculating the first complexity score for the first code portion further comprises calculating the first complexity score for the first code portion based on a combination of a plurality of the one or more complexity metrics.

18. The apparatus of claim 15, wherein calculating the first complexity score for the first code portion further comprises calculating the first complexity score for the first code portion based on a weighted combination of a plurality of the one or more complexity metrics.

19. The apparatus of claim 13, wherein the memory stores computer program instructions that, when executed, cause the processing device to update the generative artificial intelligence model based on the translation accuracy score.

20. A computer program product comprising a computer readable storage medium, wherein the computer readable storage medium comprises computer program instructions that, when executed:
receive a first code portion of a first programming language;
convert the first code portion to a second code portion of a second programming language by a generative artificial intelligence model;
convert the second code portion to a third code portion of the first programming language by the generative artificial intelligence model;
calculate a first complexity score for the first code portion;
calculate a second complexity score for the third code portion; and
calculate a translation accuracy score of the converting of the first code portion to the second code portion based on a comparison of the first complexity score and the second complexity score.
